(19) United States
(12) Patent Application Publication
(10) Pub. No.: US 2005/0221061 A1
(43) Pub. Date: Oct. 6, 2005

(54) Method and apparatus for forming shiplap edge in air duct board using molding and machining

(76) Inventors: Murray S. Toas, Norristown, PA (US); Greg Mattix, Collegeville, PA (US); John Forsythe, Las Vegas, NV (US); Dave Pacana, Spring City, PA (US)

Correspondence Address: DUANE MORRIS, LLP;IP DEPARTMENT, ONE LIBERTY PLACE, PHILADELPHIA, PA, 19103-7396, US

(21) Appl. No.: 10/817,342

(22) Filed: Apr. 2, 2004

(51) Int. Cl. B32B 23/02

(52) U.S. Cl. 428/192

(57) ABSTRACT

A Method for forming a shiplap edge in a duct board comprises the steps of: molding a shiplap edge in a first duct made of mineral fiber or mineral wool, so that the molded shiplap edge has a molded edge thickness, and machining the molded shiplap edge to a desired machined edge thickness that is less than the molded edge thickness.

### FIELD OF THE INVENTION

The present invention relates generally to building products, and more specifically to methods and apparatus for forming mineral fiber, airduct board with a shiplap edge.

### BACKGROUND

Mineral fiber, air duct board products are commonly manufactured with male and female shiplap edges on opposite sides The shiplap edge is used to permit the connection of successive formed tubular fiberboard pieces in the field.

U.S. Pat. No. 4,226,662 to McCort is incorporated herein in its entirety. McCort teaches that the shiplap edge may be molded or routed into a mineral fiber board. McCort is concerned with a problem that may occur when the edges of the fiberboard are either molded or routed to form a kerfed shiplap edge. The damage to the kerfed shiplap edges often includes the splitting or delamination of the layers of fibers in the male shiplap end, thereby preventing its insertion into the female end in the field. McCort also notes that molded shiplap edges fail to provide the truly square corners produced by routing, and delamination of the male shiplap edge can still occur. In McCort's solution to this problem, a portion of an edge of the board is cut away, a liquid adhesive is applied to the remaining edge portion, and the liquid adhesive is dried.

An alternative method of forming a shiplap edge is desired.

### SUMMARY OF THE INVENTION

In some embodiments, a method for forming a shiplap edge in a duct board, comprises the steps of: molding a shiplap edge in a first duct board made of mineral fiber or mineral wool, the molded shiplap edge having a molded edge thickness, and machining the molded shiplap edge to a desired machined edge thickness that is less than the molded edge thickness.

In some embodiments, apparatus for forming a shiplap edge in a duct board comprises: at least one mold for molding a shiplap edge in a first duct board made of mineral fiber or mineral wool, so that the molded shiplap edge has a molded edge thickness, and a cutter or grinder for machining the molded shiplap edge to a desired machined edge thickness less than the molded edge thickness.

In some embodiments, a duct board material comprises a board of mineral fiber or mineral wool. The board is formed by molding a shiplap edge in a first duct board made of mineral fiber or mineral wool, so that the molded shiplap edge has a molded edge thickness, and machining the molded shiplap edge to a desired machined edge thickness that is less than the molded edge thickness.

### BRIEF DESCRIPTION OF THE DRAWINGS

FIG. 1 is a diagram of an exemplary system for forming a duct board material.

FIG. 2 is a side elevation view of the curing oven of FIG. 1, with the flights configured for forming a first duct board having a first board thickness.

FIG. 3 is a side elevation view of the curing oven of FIG. 1, with the flights configured for forming a second duct board having a second board thickness.

FIG. 4 is a plan view of the machining station shown in FIG. 1.

FIG. 5 is an elevation view of the machining station viewed from section line 5-5 of FIG. 4.

FIG. 6 is a side elevation view of a duct board material formed by the method and apparatus of FIG. 1.

FIG. 7 is an isometric view of two air duct sections formed from the duct board material of FIGS. 1-5.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

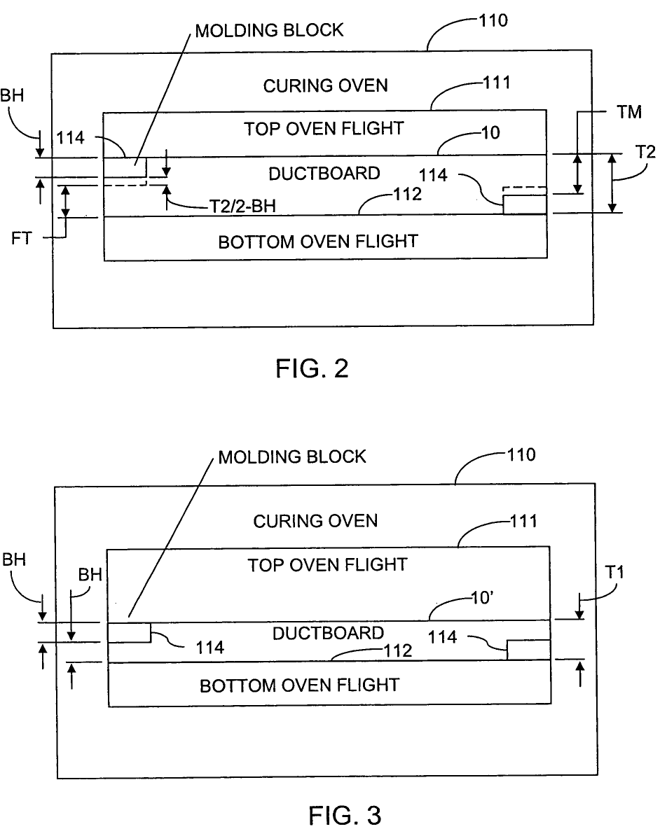

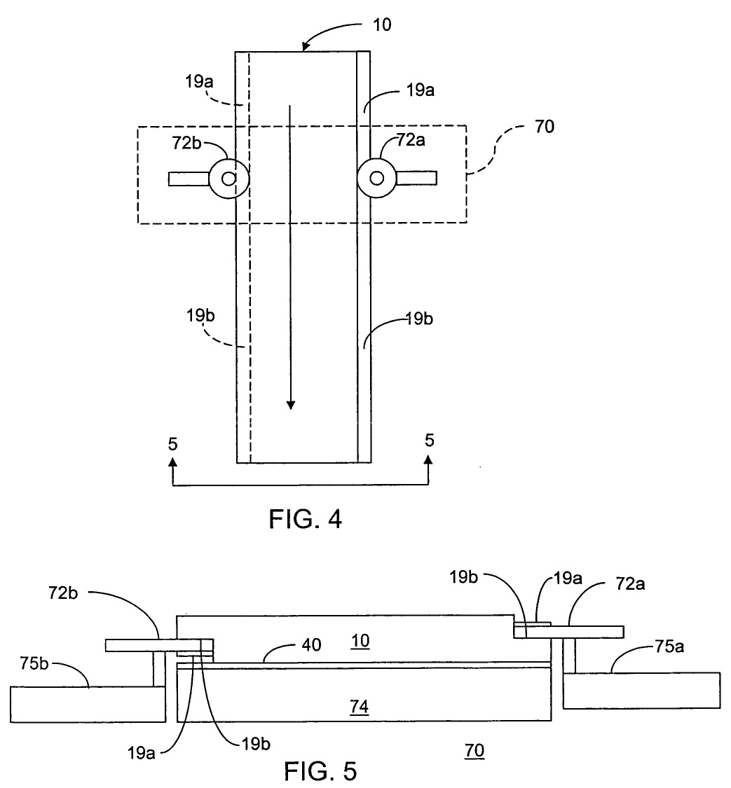

Examples are described below in which a shiplap edge is formed in a duct board in a two-step process. A molded shiplap edge 19a (FIG. 4) is molded in a first duct board 10 made of mineral fiber or mineral wool. The molded shiplap edge 19a has a molded edge thickness TM (FIG. 2). The molded shiplap edge 19a is machined to a desired machined edge thickness FT that is less than the molded edge thickness TM, thereby forming a machined shiplap edge 19b (FIG. 4).

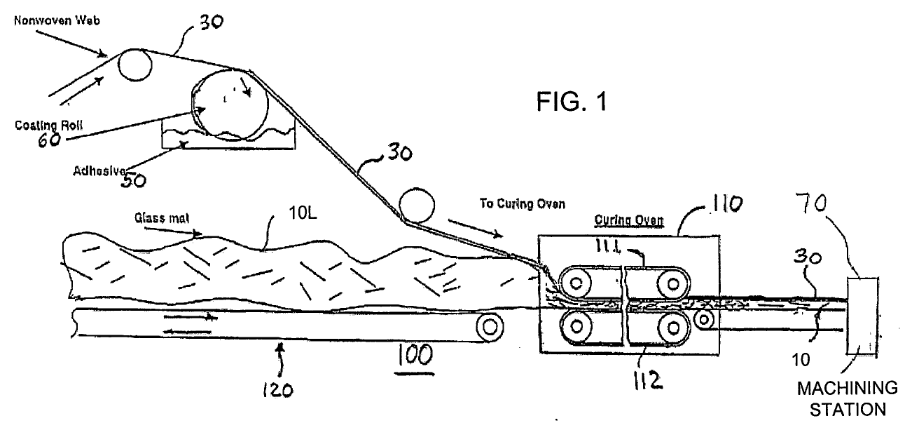

FIG. 1 is a schematic diagram of an exemplary apparatus 100 for forming the duct board material 10. The apparatus 100 packs loose mineral wool or mineral fiber (e.g., fiber glass material) 10L into a fiber board layer 10. The exemplary glass layer 10 is constructed from a low density fibrous glass wool. The glass fibers may be formed by a rotary process, in which glass from a furnace (not shown) enters rotary spinners (not shown), where the glass is formed into long fibers in a loose glass wool 10L, and the fibers are coated with a resin binder, such as phenol urea formaldehyde (PUFA), for example in a spraying process. The fibers are loaded onto a conveyor 120 and delivered to the curing oven 110. The fiber board layers 10 are formed by compressing the blankets of resin coated glass fibers 10L from an initial thickness of about 30 centimeters (12 inches) to an appropriate thickness and density and curing the resin binder. The compression is performed using two conveyor flights 111 and 112. Typically, the curing step includes blowing hot air through the blanket 10L. Also contained within the curing oven 110 are molding blocks sized and shaped to compress an edge portion of the duct board material from a board thickness to the molded edge thickness, to form a molded shiplap edge 19a, as described below.

At least a portion of the oven 110 has an adjustable height. For example, a height of the mold may be adjustable relative to a bottom surface of the first duct board. A molding block 114 is attached to the portion of the oven 110 having an adjustable height. A second mold 114 is not required to change height, and is used to form an additional shiplap edge in the first duct board opposite the first shiplap edge. For example, the curing oven 110 may contain two molding blocks 114 (shown in FIGS. 2 and 3), which may be attached or coupled to the conveyor flights 111 and 112, or may otherwise be fixtured to the oven in such a manner that the molding blocks move vertically, or stay at a constant height, along with the respective oven flights 111 and 112. Thus, if the top oven flight 111 moves up or down, the top molding block 114 moves up or down by the same distance. Similarly, if the bottom flight 112 stays at a constant vertical height, the bottom molding block 114 also remains at a constant vertical height. One of ordinary skill in the art will understand that in other embodiments, the top flight 111 may remain at a constant height, and the bottom flight 112 may move up and down; in such embodiments, the top molding block 114 stays at a constant height and the bottom molding block 114 changes height along with the bottom flight 112. In still other embodiments, both upper and lower flights 111 and 112 may move, in order to form the desired spacing between the upper and lower flights.

Assuming that the fibers emerge from the rotary spinning apparatus (not shown) at a relatively constant mass flow rate, the mass per unit area is controlled by the line speed of the forming conveyor 120 and the oven flights 111 and 112, and the density is a function of the line speed and the spacing between flights 111 and 112 (i.e., the board thickness). The board thickness, on the other hand, is simply determined by the spacing between flights 111 and 112.

FIGS. 2 and 3 are elevation views of the curing oven 110 shown in FIG. 1, as seen from a direction of the conveyor 120. FIG. 2 shows the curing oven 110 configured for forming a first duct board 10, and FIG. 3 shows the same curing oven with the top flight 111 adjusted to form a second duct board 10′. For ease of explaining the operation of the curing oven, FIG. 3 is described first.

FIG. 3 shows the oven 110 configured for forming a molded shiplap edge in the second duct board 10′. The molding blocks 114 are shown coupled to the top oven flight 111 and bottom oven flight 112. The molding blocks have a block height BH, which may be, for example, 0.5 inch (1.27 cm) for forming a 0.5 inch molded shiplap edge in a standard 1.0 inch thick (2.54 cm) duct board, or 0.75 inch (1.91 cm) for forming a 0.75 inch molded shiplap edge in a standard 1.5 inch (3.81 cm) thick duct board. As shown in FIG. 3, the thickness BH of the molding blocks 114 is one half the board thickness T1 of a duct board material 10′ for which a molded shiplap edge is formed. Note that in FIG. 3, the final shiplap edge thickness BH is achieved by molding alone.

FIG. 2 shows the same curing oven 110, with the relative heights of the flights 111 and 112 configured for forming a thicker duct board 10. For example, if the flights 111 and 112 are spaced 1.5 inches (3.81 cm) apart in FIG. 3 for forming a 1.5 inch duct board 10′ with a 0.75 inch molded shiplap edge, then the same flights 111 and 112 may be spaced 2.0 inches (5.08 cm) apart for forming a 2 inch duct board 10 in FIG. 2. As shown in FIG. 2, the desired final thickness FT of the shiplap edge (final thickness shown in phantom) is one half the board thickness T2 of the first duct board. For example, if the board thickness T2 of duct board 10 is 2.0 inches, then the desired final shiplap edge thickness FT is 1.0 inch.

As shown in FIG. 2, if the same molding blocks 114 (with thickness BH of 0.75 inch) used to form the 0.75 inch molded shiplap edge in 1.5 inch board are also used for forming a shiplap edge in the first duct board 10 with a 2.0 inch board thickness, the thickness TM of the molded shiplap edge would be 1.25 inch (3.18 cm), which is greater than one half of the board thickness T2 of the first duct board 10. Specifically, the molded shiplap edge has an excess thickness of T2/2-BH, where T2/2 is one half the board thickness T2, and BH is the block height of the molding block 114. In this example, the excess thickness T2/2-BH=1.0−0.75=0.25 inch. As shown in FIGS. 1 and 4, the exemplary apparatus includes a machining station 70 for removing the excess material from the molded shiplap edge, to form a machined shiplap edge having the desired thickness FT of T2/2.

FIG. 4 is a plan view showing a portion of the duct board material 10 downstream of the curing oven 110 shown in FIG. 1. The duct board material 10 is shown passing through a machining station 70. The machining station 70 includes means for machining the molded shiplap edge to a desired machined edge thickness FT less than the molded edge thickness TM. The duct board material 10 entering the machining station 70 has a molded shiplap edge 19a of a first thickness (molded thickness) TM greater than one half of the board thickness T2. In the machining station, the molded shiplap edge 19a is machined to form a machined shiplap edge 19b having a desired thickness of T2/2. The machining means may include a cutter or grinder 72a, 72b for machining the molded shiplap edge to the desired machined edge thickness FT, which is less than the molded edge thickness TM. In other embodiments, the machining means may include a router or an end mill, or an equivalent tool. Thus, in the machining station 70, an amount of material is removed to reduce the thickness of the shiplap edge 19b by the quantity (T2/2-BH), where BH is the block height of the molding blocks in curing oven 110.

FIG. 5 is an elevation view showing the machining station 70 as seen from section line 5-5 of FIG. 4. In this example, the machining means includes two grinding wheels 72a and 72b, above and below the respective shiplap edges. In FIG. 5, the molded shiplap edges 19a are visible behind the grinding wheels 72a and 72b. (The thickness of the molded shiplap edge 19a is exaggerated for this purpose.) The machined shiplap edges 19b are in the foreground, in front of the grinding wheels 72a and 72b. An exemplary grinding wheel is a Norton Gemini Type 27, 4½″ Diameter, ¼″ thick (deep) sold by Saint-Gobain Abrasives, Inc., of Worcester, Mass., which may be operated at 10,000 rpm, using 120 VAC, 6.0 AMP for machining the shiplap edges.

Also shown in FIG. 5 is an exterior facing 40 (e.g., foil-scrim-kraft, or FSK), which may be applied between the exit of the curing oven and the entrance to the machining station 70. The facing 40 may be applied either before or after the machining step is performed to machine the molded shiplap edges 19a into the machined shiplap edges 19b. In alternative embodiments, the FSK layer 40 is applied downstream of the machining station, in which case the FSK layer 40 would not appear in the cross section of FIG. 5. Because the exterior facing 40 is not cured, it may be applied to the duct board 10 offline. Also shown in FIG. 5 is a table or conveyor 74 for supporting the board 10 while it passes through the machining station.

In some embodiments, at least a portion of the fixtures 75a, 75b have an adjustable height, and the cutter or grinder 72a, 72b is attached to the portion of the fixture. A variety of height adjustments may be used, including a telescoping tube, or a means as simple as putting a block (not shown) under each fixture 75a, 75b. Using an adjustable height fixture for the machining means, it is possible to change the amount of material being machined from the molded shiplap edges 19a.

For example, instead of using 0.75 inch molding blocks 114, 0.5 inch (1.27 cm) molding blocks may be used. A 0.5 inch molding block is suitable for forming a 0.5 inch molded shiplap edge in a 1.0 inch (2.54 cm) duct board (which does not require any machining). By separating the flights 111, 112 to a distance of 1.5 inches (3.81 cm), the same 0.5 inch molding block may be used to form a 1.0 inch thick molded shiplap edge in a 1.5 inch duct board, after which 0.25 inch is machined off to form a final 0.75 inch machined shiplap edge in the 1.5 inch duct board. By separating the flights 111, 112 further, to a separation of 2.0 inches (5.08 cm), the same 0.5 inch molding block may be used to form a 1.5 inch thick molded shiplap edge in a 2.0 inch duct board, after which 0.5 inch is machined off to form a final 1.0 inch machined shiplap edge in the 2.0 inch duct board. In this manner, a single set of molding blocks may be used to manufacture duct boards of a variety of sizes, including three or more sizes. To achieve this, a curing oven 110 is used that manufactures duct boards of at least three different board thicknesses. The height of the portion of the oven to which one of the molding blocks 114 is fixed is adjustable by at least a distance that is equal to a difference between two different board thicknesses of duct boards that are passed through the oven.

A method is thus provided for forming a shiplap edge 19b in a duct board 10. A molded shiplap edge 19a is molded in a first duct board 10 made of mineral fiber or mineral wool. The molded shiplap edge 19a is then machined to form a machined shiplap edge 19b having a desired machined edge thickness FT that is less than the molded edge thickness TM.

The molding step includes compressing an edge portion of the first duct board 10 from a board thickness T2 to the molded edge thickness TM, thereby to form the molded shiplap edge 19a. Thus, the molding step includes forming a region 19a of increased density fibrous material in the shiplap edge 19a. This improves the strength and stiffness of the shiplap edge, compared to a shiplap edge solely formed by machining. In one example, using 0.75 inch molding blocks 114 on 2.0 inch duct board, a ratio of the molded edge thickness to the board thickness is about 1.25:2, corresponding to a 60% density increase. In another example, using 0.5 inch molding blocks 114 on 1.5 inch duct board, a ratio of the molded edge thickness to the board thickness is about 1.0:1.5, corresponding to a 50% density increase. In still another example, using 0.5 inch molding blocks 114 on 2.0 inch duct board, a ratio of the molded edge thickness to the board thickness is about 1.5:2.0, corresponding to a 33% density increase.

The machining may comprise grinding, cutting, routing, end milling, or the like. Using the example 0.75 inch molding blocks for 2.0 inch duct board, a ratio of the machined edge thickness to the molded edge thickness is about 1:1.25. Using this method, an amount of material machined from the board to achieve the desired machined edge thickness is substantially less than one half of a board thickness of the duct board.

The method may further comprise using the same molding blocks to manufacture a second duct board having a different thickness from the first duct board. Using this technique, the machined edge thickness of the shiplap edge of the first duct board is about one half of the board thickness of the first duct board, and a molded edge thickness of the shiplap edge of the second duct board is about one half of the board thickness of the second duct board.

For this purpose, the method further comprises changing a height of the mold between molding the shiplap edge of the first duct board and molding the shiplap edge of the second duct board. In an example wherein the mold 114 is attached to a portion (e.g., flight 111) of a curing oven 110 that determines the thickness dimensions of the 2.0 inch and 1.5 inch duct boards, and through which the first and second duct boards pass, this may involve changing a height of the portion 111 of the oven 110 between molding the shiplap edge of the first duct board and molding the shiplap edge of the second duct board. In an example where one molding block is attached to a constant-height flight, and the other molding block is attached to a variable-height flight, the height changing step includes changing the height of the variable-height flight of the oven by a distance that is about equal to a difference between the board thickness of the first duct board and the board thickness of the second duct board. In other embodiments, the heights of either or both of the flights may be adjusted, so long as the spacing between flights is equal to the desired board thickness of the duct board to be produced.

One of ordinary skill will understand that a single set of molding blocks may be used for forming shiplap edges in any number of three or more different duct board thicknesses, merely by changing a height of the mold (e.g., oven flight height) and changing the height of the machining means between fabrication of any two successive ductboards having different thicknesses from each other.

The example shown above provides an “online” process, in which the shiplap edges are formed in the duct board material 10 before the duct board material is cut into individual (e.g., 10 foot or 3.05 meter) lengths. In other embodiments, the molded shiplap edges 19a may alternatively be machined to form the machined shiplap edges 19b in an offline process, in which the shiplap edges are machined in the duct board material 10 to one half the board's thickness after the duct board material is cut into individual lengths. In the case of the offline process, the machining station 70 does not have to be in close proximity to the duct board fabrication apparatus 100.

Using the above described method and apparatus, a duct board material is formed, by molding a shiplap edge 19a in a first duct board 10 made of mineral fiber or mineral wool, so that the molded shiplap edge 19a has a molded edge thickness TM, and machining the molded shiplap edge 19a to a desired machined edge thickness FT that is less than the molded edge thickness. The result is a duct board having a machined shiplap edge, with a density of the material in the molded shiplap edge is substantially greater than a density of the material in the remainder of the first duct board.

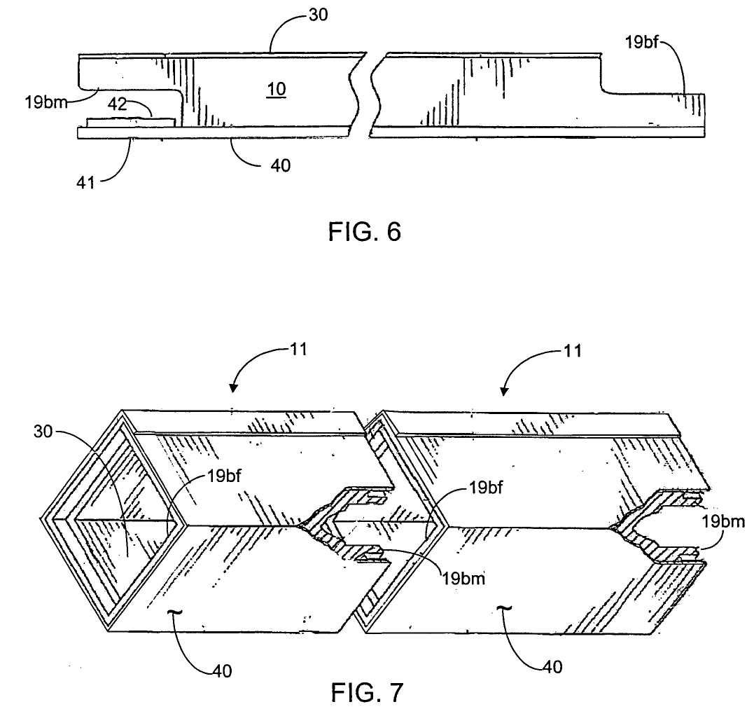

FIG. 6 is a cross sectional view of an exemplary duct board 10, and FIG. 7 is an isometric view of two duct sections 11, each formed from a section of the duct board material 10. With an interior facing 30 and an exterior facing 40 applied to the insulation material 10, the interior and exterior surfaces of the duct board material are defined. One of the shiplap edges 19b is identified as the male shiplap edge 19bm, and the other shiplap edge is identified as the female shiplap edge 19bf. The duct board may have a flap 41 of facing 40 extending to the end of the male shiplap edge 19bm. The flap 41 may have an adhesive means 42, such as a hot melt adhesive or a pressure sensitive tape, for adhering the flap 41 of the mail shiplap edge 19bm to the female shiplap edge of the adjacent section 11. As shown in FIG. 7, the duct board 10 is folded into a tubular structure 11. The male shiplap edge 19bm can be inserted in the female shiplap edge 19bf of an adjacent section of duct 11, so that the two sections 11 are joined to each other.

The rigid fiberglass board 10 may have a density that is less than 96 kilograms/meter³ (6 lb./foot³) and greater than or equal to about 56 kilograms/meter³ (3.5 lb./foot³), preferably less than 75 kilograms/meter³ (4.7 lb./foot³), and greater than or equal to 64 kilograms/meter³ (4.0 lb./foot³). A preferred density is about 68 kilograms/meter³ (4.2 lb./foot³). For a 2.54 centimeter thick board 10 of this density range with an EI 475 rating, the mass per unit area is less than 0.24 grams/centimeter² (227 grams/foot²) and greater than or equal to about 0.14 grams/centimeter² (132 grams/foot²), preferably less than 0.26 grams/centimeter² (178 grams/foot²) and greater than or equal to about 0.16 grams/centimeter² (151 grams/foot²). A preferred mass per unit area is 0.17 grams/centimeter² (159 grams/foot²). For thicker boards, the density may be lowered. For example, a 2.0 inch (5.08 cm) board may have a mass per unit area of 318 grams/foot² or less, corresponding to a density of 4.2 lb./foot³.

The exterior facing 40 improves the strength of the duct board material and provides a vapor retarder. Although a preferred exterior facing is Foil-Scrim-Kraft material (FSK), other facing materials that provide a vapor retarder may be used.

A bonded, non-woven mat facing 30 may optionally be adhered to the interior surface. A preferred material for the non-woven mat facing 30 includes glass filaments in a resinous binder. More preferred materials include a thin, bonded, nonwoven fiber glass mat oriented in a random pattern, having sized glass fibers bonded with a resinous binder. An exemplary mat is formed of randomly oriented glass fibers about 3.2 centimeters long bonded in a process similar to that used for making paper. Thinner mat materials are preferred, because they allow better penetration of the adhesive that bonds the mat 30 to fiber board 10.

An example of a preferred material for the non-woven mat facing 30 is “Dura-Glass®” R8940 wet laid glass non-woven mat, manufactured by Johns Manville of Toledo, Ohio. The exemplary non-woven mat facing 30 has a thickness of about 0.023 centimeter (0.009 inch) and has a mass per unit area of about 38.7 grams/meter². Another example is a wet laid fiber glass and polyester fiber non-woven mat with a latex binder and having a thickness of, for example, 0.03 centimeter (0.012 inch), and a weight/square of 70 grams/m².

The duct board material 10 has an elastic modulus-moment of inertia product (El) of at least 475 pound-inch². Some preferred embodiments have an EI of about 475 pound-inch², and other preferred embodiments (such as the have an EI of at least 800 pound-inch². EI 475 materials are suitable for most residential duct applications. EI 800 materials are more commonly used for commercial construction, where higher pressure and greater air velocity is more common, but they can also be used in residential construction.

The exemplary duct board material 10 may be formed with a variety of thicknesses. A typical thickness for EI 475 duct board material 10 is about 2.54 centimeters (1.0 inch). A typical thickness for EI 800 duct board material 10 is 3.81 centimeters (1.5 inches). EI 800 duct board material is also commonly made with a thickness of about 5.1 centimeters (2 inches).

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A method for forming a shiplap edge in a duct board, comprising the steps of:
(a) molding a shiplap edge in a first duct board made of mineral fiber or mineral wool, the molded shiplap edge having a molded edge thickness; and
(b) machining the molded shiplap edge to a desired machined edge thickness that is less than the molded edge thickness.

2. The method of claim 1, wherein the molding step includes forming a region of increased density fibrous material in the shiplap edge.

3. The method of claim 1, wherein the molding step includes compressing an edge portion of the first duct board from a board thickness to the molded edge thickness, thereby to form the shiplap edge.

4. The method of claim 3, wherein a ratio of the molded edge thickness to the board thickness is about 1.25:2.

5. The method of claim 4, wherein a ratio of the machined edge thickness to the molded edge thickness is about 1:1.25.

6. The method of claim 1, further comprising:
molding a shiplap edge in a second duct board made of mineral fiber or mineral wool using a same mold that is used to perform step (a), wherein:
the first and second duct boards have different board thicknesses from each other,
the machined edge thickness of the shiplap edge of the first duct board is about one half of the board thickness of the first duct board, and
a molded edge thickness of the shiplap edge of the second duct board is about one half of the board thickness of the second duct board.

7. The method of claim 6, further comprising changing a height of the mold between molding the shiplap edge of the first duct board and molding the shiplap edge of the second duct board.

8. The method of claim 6, wherein the mold is attached to a portion of a curing oven that determines the thickness dimensions of the first and second duct boards, and through which the first and second duct boards pass, the method further comprising changing a height of the portion of the oven between molding the shiplap edge of the first duct board and molding the shiplap edge of the second duct board.

9. The method of claim 8, wherein the height changing step includes changing the height of the portion of the oven by a distance that is equal to a difference between the board thickness of the first duct board and the board thickness of the second duct board.

10. The method of claim 8, further comprising using a constant height second mold attached to a portion of the oven that does not change height, to form an additional shiplap edge in the first duct board opposite the first shiplap edge.

11. The method of claim 6, wherein a cutter or grinder is attached to a fixture through which at least the first duct board passes.

12. The method of claim 11, further comprising
changing a height of the fixture; and
molding a shiplap edge in a third duct board having a third board thickness different from the thicknesses of the first and second duct boards, using the same mold that is used to perform step (a).

13. The method of claim 1, wherein the machining step comprises grinding.

14. Apparatus for forming a shiplap edge in a duct board, comprising:
at least one mold for molding a shiplap edge in a first duct board made of mineral fiber or mineral wool, so that the molded shiplap edge has a molded edge thickness; and
a cutter or grinder for machining the molded shiplap edge to a desired machined edge thickness less than the molded edge thickness.

15. The apparatus of claim 14, wherein the mold is sized and shaped to compress an edge portion of the first duct board from a board thickness to the molded edge thickness, thereby to form the shiplap edge.

16. The apparatus of claim 14, wherein a height of the mold is adjustable relative to a bottom surface of the first duct board.

17. The apparatus of claim 16, further comprising a fixture through which the first duct board passes, at least a portion of the fixture having an adjustable height, the cutter or grinder being attached to the portion of the fixture.

18. The apparatus of claim 16, further comprising a curing oven that determines the thickness dimensions of the first and second duct boards, and through which the first duct board passes, at least a portion of the oven having an adjustable height, the mold being attached to the portion of the oven.

19. The apparatus of claim 18, wherein:
the oven manufactures duct boards of at least two different board thicknesses, and
the height of the portion of the oven is adjustable by at least a distance that is equal to a difference between two different board thicknesses of duct boards that are passed through the oven.

20. The apparatus of claim 14, further comprising a second mold that does not change height, used to form an additional shiplap edge in the first duct board opposite the first shiplap edge.

21. Apparatus for forming a shiplap edge in a duct board, comprising:
at least one mold for molding a shiplap edge in a first duct board made of mineral fiber or mineral wool, so that the molded shiplap edge has a molded edge thickness; and
means for machining the molded shiplap edge to a desired machined edge thickness less than the molded edge thickness.

22. A duct board material, comprising:
a board of mineral fiber or mineral wool, the board being formed by molding a shiplap edge in a first duct board made of mineral fiber or mineral wool, so that the molded shiplap edge has a molded edge thickness, and machining the molded shiplap edge to a desired machined edge thickness that is less than the molded edge thickness.

23. The duct board material of claim 22, wherein an amount of material machined from the board to achieve the desired machined edge thickness is substantially less than one half of a board thickness of the duct board.

24. The duct board material of claim 22, wherein a density of the material in the molded shiplap edge is substantially greater than a density of the material in the remainder of the first duct board.
